(19) United States
(12) Patent Application Publication
(10) Pub. No.: US 2023/0173758 A1
(43) Pub. Date: Jun. 8, 2023

(54) Catalytic Converter System for a Build Chamber of a Three-Dimensional Printer

(71) Applicant: Essentium, Inc., Pflugerville, TX (US)

(72) Inventor: Charles Brandon Sweeney, Pflugerville, TX (US)

(21) Appl. No.: 17/545,541

(22) Filed: Dec. 8, 2021

(51) Int. Cl. B29C 64/364; B29C 64/386; B29C 64/295; B29C 64/118

(52) U.S. Cl. CPC B29C 64/364; B29C 64/118; B29C 64/295; B29C 64/386; B33Y 30/00

(57) ABSTRACT

A catalytic converter system for a build chamber volume of a three-dimensional printer includes a catalytic converter including a catalyst substrate having a catalytic layer having a predetermined reduction efficiency temperature. The catalytic converter system also includes a blower assembly disposed upstream and in fluid communication with the catalytic converter and the build chamber volume, where the blower assembly circulates exhaust gas from the build chamber volume into the catalytic converter. The catalytic converter system also includes a heater configured to heat the catalyst substrate of the catalytic converter to the predetermined reduction efficiency temperature, and one or more controllers in electronic communication with the blower assembly and the heater. The controller modulates an amount of power provided to the heater and an amount of power provided to the blower assembly.

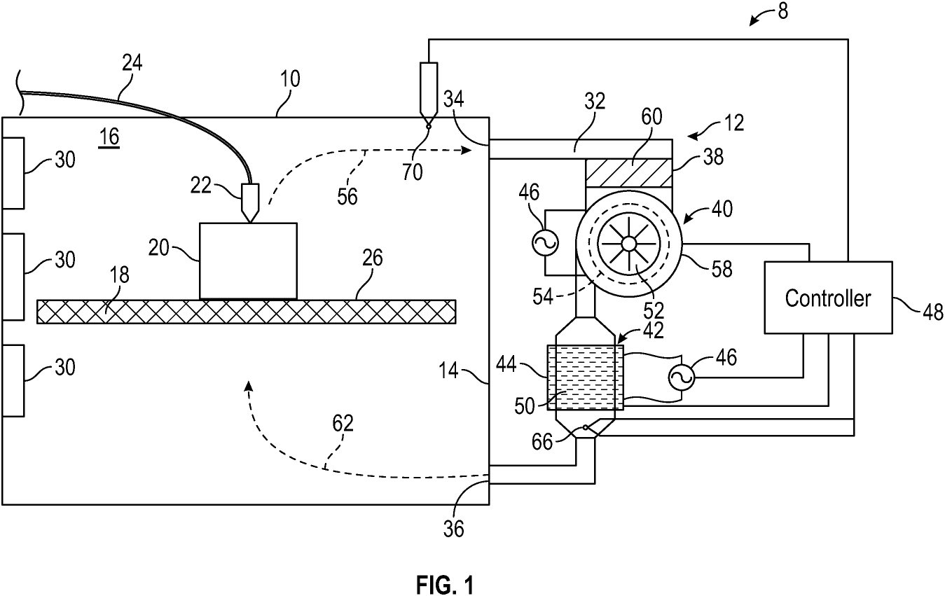

### FIELD

The present disclosure is directed to a catalytic converter system for a build chamber of a three-dimensional printer.

### BACKGROUND

The statements in this section merely provide background information related to the present disclosure and may or may not constitute prior art.

Three-dimensional printing, which is also referred to as additive manufacturing, creates printed components based on computer models. One example of a three-dimensional printing technique is fused deposition molding (FDM), which employs a continuous filament constructed of a thermoplastic material that is fed to a heated nozzle. The three-dimensional printer may include an enclosure that is referred to as a build chamber, which contains the printed component during the build process. The build chamber provides a volume of heated air that is usually maintained some threshold below either a glass transition temperature or a melting point of the thermoplastic material to facilitate fusion between successive layers of the printed component, and to reduce warping and inconsistent cooling during a print cycle.

The build process that the three-dimensional printer undergoes to create a printed component results in contaminants such as particulate matter, ozone, and volatile organic compounds (VOCs) being released into the build chamber. One existing solution for removing the contaminants from the build chamber includes a high-efficiency particulate air (HEPA) filter combined with activated carbon filters, which is also referred to as a scrubber. A scrubber is an accessory that is installed to the three-dimensional printer as a stand-alone unit and is connected to the build chamber using a duct or hose. However, there are several drawbacks associated with scrubbers such as, but not limited to, additional cost and complexity, excess noise, and ongoing maintenance for replacing filters. Moreover, negative pressure is created by the scrubber within the build chamber when evacuating the chamber air, which in turn significantly cools the build chamber.

Thus, while current three-dimensional printers achieve their intended purpose, there is a need for an improved approach for removing contaminants from the build chamber of the three-dimensional printer.

### SUMMARY

According to several aspects, a catalytic converter system for a build chamber volume of a three-dimensional printer is disclosed. The catalytic converter system includes a catalytic converter including a catalyst substrate having a catalytic layer having a predetermined reduction efficiency temperature. The system also includes a blower assembly disposed upstream and in fluid communication with the catalytic converter and the build chamber volume, where the blower assembly circulates exhaust gas from the build chamber volume into the catalytic converter. The system also includes a heater configured to heat the catalyst substrate of the catalytic converter to the predetermined reduction efficiency temperature, and one or more controllers in electronic communication with the blower assembly and the heater. The one or more controllers executes instructions to receive an air temperature signal indicative of an air temperature within the build chamber volume and a catalyst temperature indicative of a temperature of the catalyst substrate. The one or more controllers modulate an amount of power provided to the heater based on at least the air temperature of the build chamber volume, the catalyst temperature, and the predetermined reduction efficiency temperature of the catalytic layer of the catalyst substrate. The one or more controllers modulate an amount of power provided to the blower assembly based on at least the catalyst temperature and the predetermined reduction efficiency temperature of the catalytic layer of the catalyst substrate.

In another aspect, a three-dimensional printer having a build chamber volume and a catalytic converter system for removing emissions from the build chamber volume of the three-dimensional printer is disclosed. The catalytic converter system includes a catalytic converter including a catalyst substrate having a catalytic layer having a predetermined reduction efficiency temperature. The system also includes a blower assembly disposed upstream and in fluid communication with the catalytic converter and the build chamber volume, where the blower assembly circulates exhaust gas from the build chamber volume into the catalytic converter. The system also includes a heater configured to heat the catalyst substrate of the catalytic converter to the predetermined reduction efficiency temperature. Finally, the system includes one or more controllers in electronic communication with the blower assembly and the heater, where the one or more controllers executes instructions to receive an air temperature signal indicative of an air temperature within the build chamber volume and a catalyst temperature indicative of a temperature of the catalyst substrate. The one or more controllers modulate an amount of power provided to the heater based on at least the air temperature of the build chamber volume, the catalyst temperature, and the predetermined reduction efficiency temperature of the catalytic layer of the catalyst substrate. The one or more controllers modulate an amount of power provided to the blower assembly based on at least the catalyst temperature and the predetermined reduction efficiency temperature of the catalytic layer of the catalyst substrate.

Further areas of applicability will become apparent from the description provided herein. It should be understood that the description and specific examples are intended for purposes of illustration only and are not intended to limit the scope of the present disclosure.

### BRIEF DESCRIPTION OF DRAWINGS

The drawings described herein are for illustration purposes only and are not intended to limit the scope of the present disclosure in any way.

The FIGURE is a schematic diagram illustrating a three-dimensional printer including a build chamber and the disclosed catalytic converter assembly, according to an exemplary embodiment.

### DETAILED DESCRIPTION

The following description is merely exemplary in nature and is not intended to limit the present disclosure, application, or uses.

The present disclosure is directed to a catalytic converter system for a build chamber of a three-dimensional printer, where the catalytic converter system includes a heater configured to heat a catalytic converter to a predetermined reduction efficiency and a blower configured to circulate air through the build chamber. Referring now to the FIGURE, a diagram of a three-dimensional printer 8 including a build chamber 10 and a catalytic converter system 12 is shown. The catalytic converter system 12 is configured to reduce emissions within a build chamber volume 16 of the three-dimensional printer 8. The three-dimensional printer 10 includes a build plate 18 for supporting a printed component 20 and a nozzle 22 for heating and depositing a filament 24 onto a build surface 26 of the build plate 18 to create the printed component 20. The build chamber volume 16 contains the nozzle 22, the build plate 18, and the printed component 20. The three-dimensional printer 8 includes one or more heaters 30 to heat the build chamber volume 16 to a target air temperature. As explained below, the target air temperature of the build chamber volume 16 is determined based on a material the filament 24 is constructed of. The catalytic converter system 12 includes an exhaust gas conduit 32 defining an inlet 34 and an outlet 36, a particulate filter 38, a blower assembly 40, a catalytic converter 42, a heater 44, one or more power sources 46, and one or more controllers 48 in electronic communication with the blower assembly 40, the heater 44, and the one or more power sources 46.

As explained below, the heater 44 is configured to heat a catalyst substrate 50 of the catalytic converter 42 to a predetermined reduction efficiency temperature. The predetermined reduction efficiency temperature represents a threshold temperature at which a catalyst converts emissions. In one non-limiting embodiment, the predetermined reduction efficiency temperature is equal to a respective light-off temperature of the catalyst that coats the catalyst substrate 50, where the light-off temperature refers to a temperature at which the catalyst becomes more than fifty percent effective. However, it is to be appreciated that in an alternative embodiment, the predetermined reduction efficiency temperature is less then the respective light-off temperature, and therefore the catalyst is less than fifty percent effective. The blower assembly 40 includes a fan 52 coupled to a fan motor 54 and a fan shroud 58 enclosing the fan 52, where the fan 52 of the blower assembly 40 circulates exhaust gas 56 from the build chamber volume 16 into the catalytic converter 42.

In an embodiment, the catalyst is applied to materials other than the catalyst substrate 50 of the heater 40. For example, in an embodiment, the walls 14 of the build chamber volume 16 are coated with the catalyst to reduce emissions. In another example, the catalyst may be applied to other surfaces as well such as, for example, heater coils of a primary chamber heater (not shown).

The exhaust gas conduit 32 of the catalytic converter system 12 is fluidly connected to the build chamber volume 16. Specifically, the inlet 34 of the exhaust gas conduit 32 receives the exhaust gas 56 from the build chamber volume 16 and cleaned air 62 may exit the exhaust gas conduit 32 through the outlet 36 and into the build chamber volume 16. As seen in the FIGURE, the particulate filter 38 is disposed upstream of the blower assembly 40 within the exhaust gas conduit 32. The exhaust gas 56 enters the exhaust gas conduit 32 through the inlet 34 and flows through the particulate filter 38. The particulate filter 38 operates to filter the exhaust gas 56 of carbon and other particulates. Specifically, the particulate filter 38 includes a filter substrate 60 that traps carbon and other particulates of the exhaust gas 56. The exhaust gas 56 may then flow towards the fan 52 of the blower assembly 40.

The fan motor 54 of the blower assembly 40 drives the fan 52 to circulate the exhaust gas 58 through the catalytic converter system 12. The blower assembly 40 is disposed upstream and is fluidly connected to the catalytic converter 42 by the exhaust gas conduit 32. The fan motor 54 is in electronic communication with the one or more controllers 48 and controls the fan motor 54 to modulate an amount of the exhaust gas 56 flowing through the exhaust gas conduit 32. The one or more controllers 48 modulate an amount of power provided to the blower assembly 40 to either increase or decrease the amount of exhaust gas 56 flowing through the exhaust gas conduit 32. In embodiments, a speed of the fan 52 may be variably controlled based on the amount of power provided to the blower assembly 40 by the power supply 46 to either increase or decrease the amount of exhaust gas 56 flowing through the exhaust gas conduit 32.

The one or more controllers 48 modulate the amount of power provided to the blower assembly 40 based on a plurality of operating parameters of the catalytic converter 42 and the build chamber volume 16. Specifically, in an embodiment, the amount of power provided to the blower assembly 40 is based on a catalyst temperature of the catalyst substrate 50 of the catalytic converter 42, and the predetermined reduction efficiency temperature of the catalytic layer of the catalyst substrate 50. In the example as shown in the FIGURE, the one or more controllers 48 monitor the catalyst temperature of the catalyst substrate by one or more temperature sensors 66.

The amount of power provided to the blower assembly 40 is also based on an amount of emission gas released into the build chamber volume 16 during the printing process. Specifically, the amount of emission gas released into the build chamber volume 16 during the printing process depends upon factors such as, but not limited to, a print rate of the three-dimensional printer 10 as well as a type of material the filament 24 is constructed from. Specifically, some thermoplastic materials may produce a higher level of emissions when compared to other types of materials. For example, acrylonitrile butadiene styrene (ABS) releases a relatively high level of volatile organic compounds (VOCs) into the build chamber volume 16 when compared some other types of polymers such as polylactic acid (PLA). Accordingly, the air exchange requirement for the build chamber volume 16 is greater for materials such as ABS when compared to PLA. As a result, the amount of power provided to the blower assembly 40 is greater for materials such as ABS that release a relatively high amount of emissions into the build chamber volume 16 when compared to materials such as PLA, which release lower levels of emissions into the build chamber volume 16.

In addition to the amount of emission gas, the amount of power provided to the blower assembly 40 is also based on a specific type as well as a quantity of emission gas released into the build chamber volume 16 during the printing process. It is to be appreciated that some specific types of emission gas include a significantly lower light-off temperature and therefore convert into harmless gases at relatively lower temperatures when compared to other types of emission gases that are released into the build chamber volume 16 during the printing process. Furthermore, some polymers release only a relatively small amount of emission gas into the build chamber volume 16, while other polymers release significant amounts of emission gas. As an example, formaldehyde includes a significantly lower light-off temperature when compared to ethylene. As a result, the amount of power provided to the blower assembly 40 may be lower for materials with a higher light-off temperature when compared to materials with a lower light-off temperature in order to maintain heat within the catalytic converter 42. In another approach, the amount of power provided to the blower assembly 40 is based on a control scheme for controlling an air flow rate to the catalytic converter 42. Specifically, the air flow rate generated by the blower assembly 40 and the power provided to the heater 44 control the catalyst temperature of the catalyst substrate 50 of the catalytic converter 42.

The exhaust gas 56 flows from the blower assembly 40 and into the catalytic converter 42. In an embodiment, the catalyst substrate 50 of the catalytic converter 42 may be a ceramic monolith with a honeycomb structure coated with or carries the catalytic layer. The heater 44 is configured to heat the catalyst substrate 50 of the catalytic converter 42 to the predetermined reduction efficiency temperature of the catalytic layer. The heater 44 is any type of conduction heater configured to directly heat the catalyst substrate 50 such as, but not limited to, a band heater or a cartridge heater.

The one or more control modules 48 modulate an amount of power provided to the heater 44 based on at least an air temperature of the build chamber volume 16, the catalyst temperature of the catalyst substrate 50 of the catalytic converter 42, and the predetermined reduction efficiency temperature of the catalytic layer of the catalyst substrate 50. Specifically, the one or more control modules 48 modulate the amount of power provided to the heater 44 by the one or more power sources 46 to maintain the catalyst temperature of the catalyst substrate 50 of the catalytic converter 42 at the predetermined reduction efficiency temperature of the catalytic layer of the catalyst substrate 50.

In the example as shown in the FIGURE, the one or more controllers 48 monitor the air temperature of the build chamber volume 16 by one or more temperature sensors 70 disposed within the build chamber volume 16. In response to determining the temperature of the build chamber volume 16 is less than the target air temperature, the one or more controllers 48 provide power to the heater 44 to increase an amount of heat provided to the build chamber volume 16. The target air temperature of the build chamber volume 16 is based on the material the filament 24 is constructed of and is selected to facilitate fusion between successive layers, reduce warping, and reduce inconsistent cooling throughout the printed component 10 during a print cycle. When the filament 24 is constructed of an amorphous polymer, the target air temperature of the build chamber volume 16 is a predetermined threshold below a glass transition temperature of the amorphous polymer. The predetermined threshold may be selected to keep the build chamber volume 16 just below the glass transition temperature of the amorphous polymer, and in one non-limiting embodiment is about 10° C. However, if the material the filament 24 is constructed of is a semi-crystalline polymer, then the target air temperature of the build chamber volume 16 is between the glass transition temperature and a melt temperature of semi-crystalline polymer. Finally, it is to be appreciated that although the heater 44 may affect the temperature of the build chamber volume 16, a separate controller or controllers (not shown) are provided to for the one or more heaters 30 to maintain the build chamber volume 16 at the target air temperature.

The one or more control modules 48 modulate the amount of power provided to the heater 44 based on the type emissions that are released into the build chamber volume 16 during the printing process. As explained above, some specific types of emission gas include a significantly lower light-off temperature and therefore convert into harmless gases at lower temperatures when compared to other types of emission gases that are released into the build chamber volume 16 during the printing process. Specifically, for example, formaldehyde includes a significantly lower light-off temperature when compared to ethylene. As a result, the amount of power provided to the heater 44 is greater for materials with a higher light-off temperature when compared to materials with a lower light-off temperature.

It is to be appreciated that in embodiments, the blower assembly 40 and the heater 44 may be operated intermittently or continuously during a print cycle based on the type and amount of emissions released into the print chamber volume 16 and he the target air temperature of the build chamber volume 16. In an embodiment, a predetermined profile may be used to modulate the amount of power provided to the blower assembly 40 and the heater 44 during a print cycle as well, where the amount of power is modulated to maximize the amount of emissions being removed from the build chamber volume 16, while at the same time maintaining the target air temperature.

Referring generally to the figures, the disclosed catalytic converter provides various technical effects and benefits. Specifically, the catalytic converter system includes an actively heated catalyst in combination with an air circulation system for neutralizing, removing, or otherwise reducing emissions from the build chamber of a three-dimensional printer, without cooling the build chamber. In contrast, conventional approaches to remove emissions from the build chamber, such as scrubbers, may be noisy, expensive, and also reduce the temperature of the build chamber volume, which in turn results in wasted energy.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A catalytic converter system for a build chamber volume of a three-dimensional printer, the catalytic converter system comprising:
a catalytic converter including a catalyst substrate having a catalytic layer having a predetermined reduction efficiency temperature;
a blower assembly disposed upstream and in fluid communication with the catalytic converter and the build chamber volume, wherein the blower assembly circulates exhaust gas from the build chamber volume into the catalytic converter;
a heater configured to heat the catalyst substrate of the catalytic converter to the predetermined reduction efficiency temperature; and
one or more controllers in electronic communication with the blower assembly and the heater, wherein the one or more controllers executes instructions to:
receive an air temperature signal indicative of an air temperature within the build chamber volume and a catalyst temperature indicative of a temperature of the catalyst substrate;
modulate an amount of power provided to the heater based on at least the air temperature of the build chamber volume, the catalyst temperature, and the predetermined reduction efficiency temperature of the catalytic layer of the catalyst substrate; and
modulate an amount of power provided to the blower assembly based on at least the catalyst temperature and the predetermined reduction efficiency temperature of the catalytic layer of the catalyst substrate.

2. The catalytic converter system of claim 1, wherein the amount of power provided to the blower assembly is based on an amount of emission gas released into the build chamber volume.

3. The catalytic converter system of claim 1, wherein the amount of power provided to the blower assembly is based on a specific type of emission gas released into the build chamber volume.

4. The catalytic converter system of claim 1, wherein the predetermined reduction efficiency temperature is equal to a respective light-off temperature of the catalytic layer that coats the catalyst substrate.

5. The catalytic converter system of claim 1, wherein the predetermined reduction efficiency temperature is less than a respective light-off temperature of the catalytic layer that coats the catalyst substrate.

6. The catalytic converter system of claim 1, wherein the amount of power provided to the heater is further based on a specific type of emission gas released into the build chamber volume.

7. The catalytic converter system of claim 1, wherein the build chamber volume is heated to a target air temperature, and wherein the target air temperature is based on a material a thermoplastic filament is constructed from.

8. The catalytic converter system of claim 7, wherein the material the thermoplastic filament is constructed from is an amorphous polymer and the target air temperature is set to a predetermined threshold below the glass transition temperature of the material.

9. The catalytic converter system of claim 7, wherein the material the thermoplastic filament is constructed from is a semi-crystalline polymer and the target air temperature is between the glass transition temperature and the melt temperature of the material.

10. The catalytic converter system of claim 1, further comprising:
an exhaust gas conduit fluidly connected to the build chamber volume; and
a particulate filter disposed upstream of the blower assembly within the exhaust gas conduit.

11. The catalytic converter system of claim 1, wherein the heater is a conduction heater configured to directly heat the catalyst substrate of the catalytic converter.

12. A three-dimensional printer, comprising:
a build chamber volume; and
catalytic converter system for removing emissions from the build chamber volume of the three-dimensional printer, the catalytic converter system comprising:
a catalytic converter including a catalyst substrate having a catalytic layer having a predetermined reduction efficiency temperature;
a blower assembly disposed upstream and in fluid communication with the catalytic converter and the build chamber volume, wherein the blower assembly circulates exhaust gas from the build chamber volume into the catalytic converter;
a heater configured to heat the catalyst substrate of the catalytic converter to the predetermined reduction efficiency temperature; and
one or more controllers in electronic communication with the blower assembly and the heater, wherein the one or more controllers executes instructions to:
receive an air temperature signal indicative of an air temperature within the build chamber volume and a catalyst temperature indicative of a temperature of the catalyst substrate;
modulate an amount of power provided to the heater based on at least the air temperature of the build chamber volume, the catalyst temperature, and the predetermined reduction efficiency temperature of the catalytic layer of the catalyst substrate; and
modulate an amount of power provided to the blower assembly based on at least the catalyst temperature and the predetermined reduction efficiency temperature of the catalytic layer of the catalyst substrate.

13. The three-dimensional printer of claim 12, wherein the amount of power provided to the blower assembly is based on an amount of emission gas released into the build chamber volume.

14. The three-dimensional printer of claim 12, wherein the amount of power provided to the blower assembly is based on a specific type of emission gas released into the build chamber volume.

15. The three-dimensional printer of claim 12, wherein the predetermined reduction efficiency temperature is equal to a respective light-off temperature of the catalytic layer that coats the catalyst substrate.

16. The three-dimensional printer of claim 12, wherein the predetermined reduction efficiency temperature is less than a respective light-off temperature of the catalytic layer that coats the catalyst substrate.

17. The three-dimensional printer of claim 12, wherein the amount of power provided to the heater is further based on a specific type of emission gas released into the build chamber volume.

18. The three-dimensional printer of claim 12, wherein the build chamber volume is heated a target air temperature, and wherein the target air temperature is based on a material a thermoplastic filament is constructed from.

19. The three-dimensional printer of claim 18, wherein the material the thermoplastic filament is constructed from is an amorphous polymer and the target air temperature is set to a predetermined threshold below the glass transition temperature of the material.

20. The three-dimensional printer of claim 18, wherein the material the thermoplastic filament is constructed from is a semi-crystalline polymer and the target air temperature is between the glass transition temperature and the melt temperature of the material.
